(19) United States
(12) Patent Application Publication
(10) Pub. No.: US 2019/0324283 A1
(43) Pub. Date: Oct. 24, 2019

(54) DISPLAY DEVICE AND DISPLAY METHOD

(71) Applicant: HTC Corporation, Taoyuan City (TW)

(72) Inventor: Kuan-Wei Li, Taoyuan City (TW)

(73) Assignee: HTC Corporation, Taoyuan City (TW)

(21) Appl. No.: 15/956,755

(22) Filed: Apr. 19, 2018

(51) Int. Cl. G02B 27/22; G02B 27/01; H04N 13/344; G09G 3/00

(52) U.S. Cl. CPC G02B 27/2214; G02B 27/0172; G02B 2027/0178; G09G 3/003; H04N 13/344

(57) ABSTRACT

A display device and a display method thereof are provided. The display device includes an image display module and a display control circuit. The display control circuit is coupled to the image display module and is configured to receive a first image signal and a second image signal for presenting a three-dimensional image. The display control circuit is further configured to determine whether an included angle between a straight line connecting a visual center point of a first display area in the image display module and a visual center point of a second display area in the image display module and a horizontal line is not less than a predetermined angle. When the included angle is not less than the predetermined angle, the display control circuit is further configured to switch the first image signal displayed on the first display area and the second image signal displayed on the second display area to a third image signal.

### BACKGROUND

### Technical Field

The disclosure relates to a display device and a display method for the display device, and in particular, to a display device and a display method for the display device that prevent generation of double images in a three-dimensional image.

### Description of Related Art

The principle of a three-dimensional image mainly involves having the left eye and the right eye of a person respectively see slightly different images to generate a perception of a three-dimensional image based on the principle of parallax. When the left eye and the right eye respectively perceive a simulated parallax of different visual images, the person's brain automatically reorganizes the images, such that the images that the two eyes respectively see automatically fuse into a three-dimensional visual perception in the brain.

In a head-mounted display (HMD), a left-eye image and a right-eye image necessary for presenting a three-dimensional image are directly presented by two micro LCD or AMOLED display panels before the left eye and the right eye. The head-mounted display is generally in the form of goggles or a helmet to bring the display panels close to the eyes of a user, and focal lengths are adjusted through optical paths to project images to the eyes within a short distance. With a size much smaller than other conventional displays, the head-mounted display can generate an image of a wide viewing angle, and the viewing angle is generally more than 90°. Since the display panels corresponding to the left eye and the right eye are generally two completely independent display panels, the head-mounted display generally supports playback of a three-dimensional image.

Currently, three-dimensional videos or photos that are generally taken from a horizontal viewing angle, which is in line with the horizontal viewing angle of the two eyes of general people under normal conditions, and they form three-dimensional images. When a three-dimensional video or photo is viewed with a head-mounted display, if the user's head tilts by an angle over a predetermined angle, double images may occur in the three-dimensional video or photo perceived by the human eyes. If the tilt angle is over the predetermined angle, as the tilt angle increases, the issue of double images becomes more significant, which makes it impossible to clear see the three-dimensional video or photo. Therefore, how to solve the issue of double images in the three-dimensional image is one of the issues that attract attention from people skilled in the art.

### SUMMARY

The disclosure provides a display device and a display method for the display device that solve the issue of double images which is likely to occur when a three-dimensional video or photo is viewed with a head-mounted display currently available.

An exemplary embodiment of the disclosure provides a display device including an image display module and a display control circuit. The display control circuit is coupled to the image display module and is configured to receive a first image signal and a second image signal for presenting a three-dimensional image. The display control circuit is further configured to determine whether an included angle between a straight line connecting a visual center point of a first display area in the image display module and a visual center point of a second display area in the image display module and a horizontal line is not less than a predetermined angle. Moreover, the display control circuit is further configured to switch the first image signal displayed on the first display area and the second image signal displayed on the second display area to a third image signal when the included angle between the straight line connecting the visual center point of the first display area in the image display module and the visual center point of the second display area in the image display module and the horizontal line is not less than the predetermined angle.

In an exemplary embodiment of the disclosure, the image display module includes a first image display and a second image display. The first image display and the second image display are symmetrically disposed on two sides of a housing, and the first image display includes the first display area and the second image display includes the second display area.

In an exemplary embodiment of the disclosure, when the included angle between the straight line connecting the visual center point of the first display area in the image display module and the visual center point of the second display area in the image display module and the horizontal line is less than the predetermined angle, the display control circuit is further configured to display the received first image signal and the received second image signal for presenting the three-dimensional image respectively on the first display area and the second display area.

In an exemplary embodiment of the disclosure, the predetermined angle is equal to 0°±X, and X is a tolerance angle.

In an exemplary embodiment of the disclosure, the third image signal is identical to the first image signal or is identical to the second image signal.

In an exemplary embodiment of the disclosure, the display device further includes a detection circuit configured to detect positions of the first image display and the second image display, and calculate the included angle between the straight line connecting the visual center point of the first display area of the first image display and the visual center point of the second display area of the second image display and the horizontal line according to the positions of the first image display and the second image display.

In an exemplary embodiment of the disclosure, the detection circuit includes a leveler, a gyroscope, or any sensor capable of detecting linear motion, direction of linear motion, and rotational motion of the display device.

In an exemplary embodiment of the disclosure, the display device further includes a communication circuit coupled to the display control circuit. The communication circuit is configured to receive the first image signal and the second image signal via a wired network or a wireless network.

An exemplary embodiment of the disclosure provides a display method for a display device. The display device includes an image display module and a display control circuit coupled to the image display module. The image display module includes a first display area and a second display area. The display method includes the following steps. A first image signal and a second image signal for presenting a three-dimensional image are received. It is determined whether an included angle between a straight line connecting a visual center point of the first display area in the image display module and a visual center point of the second display area in the image display module and a horizontal line is not less than a predetermined angle. When the included angle between the straight line connecting the visual center point of the first display area in the image display module and the visual center point of the second display area in the image display module and the horizontal line is not less than the predetermined angle, the first image signal displayed on the first display area and the second image signal displayed on the second display area are switched to a third image signal.

In an exemplary embodiment of the disclosure, the image display module includes a first image display and a second image display symmetrically disposed on two sides of a housing.

In an exemplary embodiment of the disclosure, the method further includes the following step. When the included angle between the straight line connecting the visual center point of the first display area in the image display module and the visual center point of the second display area in the image display module and the horizontal line is less than the predetermined angle, the received first image signal and the received second image signal for presenting the three-dimensional image are displayed respectively on the first display area and the second display area.

In an exemplary embodiment of the disclosure, the method further includes the following step. Positions of the first image display and the second image display are detected, and the included angle between the straight line connecting the visual center point of the first display area of the first image display and the visual center point of the second display area of the second image display and the horizontal line is calculated according to the positions of the first image display and the second image display.

In an exemplary embodiment of the disclosure, the method further includes the following step. The first image signal and the second image signal are received via a wired network or a wireless network.

Based on the above, in the display device and the display method for the display device of the foregoing exemplary embodiments, when a user's head tilts by an angle over the predetermined angle, the first image display and the second image display may display the same image signal, which thereby solves the issue of double images at the time when the three-dimensional image is viewed.

To provide a further understanding of the aforementioned and other features and advantages of the disclosure, exemplary embodiments, together with the reference drawings, are described in detail below.

### BRIEF DESCRIPTION OF THE DRAWINGS

FIG. 1 is a schematic diagram illustrating a display device according to an exemplary embodiment.

FIG. 2 is a schematic block diagram illustrating a display device according to an exemplary embodiment.

FIG. 3 is a flowchart illustrating a display method according to another exemplary embodiment.

### DESCRIPTION OF THE EMBODIMENTS

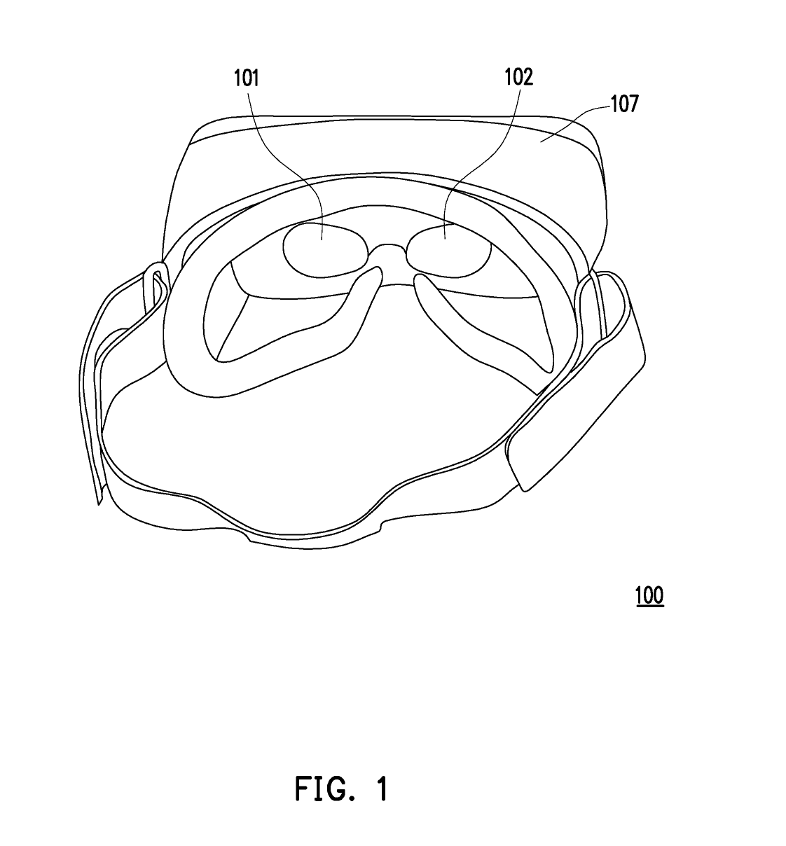

FIG. 1 is a schematic diagram illustrating a display device according to an exemplary embodiment.

Referring to FIG. 1, a display device 100 includes an image display module and a housing 107. In an exemplary embodiment, the display device 100 is, for example, a head-mounted display. However, it is understood that the display device 100 may also be another electronic device and is not limited hereto.

In the present exemplary embodiment, the image display module includes a first image display 101 and a second image display 102. The first image display 101 and the second image display 102 are symmetrically disposed on two sides of the housing 107. The first image display 101 includes a first display area, and the second image display 102 includes a second display area. When a user wears the display device 100, the first display area of the first image display 101 is close to the left eye of the user (the first image display 101 is also referred to as a left-eye display screen), and the second display area of the second image display 102 is close to the right eye of the user (the second image display 102 is also referred to as a right-eye display screen). In other words, when the user wears the display device 100 to view a three-dimensional image, the first image display 101 and the second image display 102 are completely independent of each other and project a left-eye image and a right-eye image necessary for presenting the three-dimensional image respectively to the first display area of the first image display 101 and the second display area of the second image display 102 that are correspondingly close to the left eye and the right eye, such that the left eye and the right eye can see the slightly different left-eye and right-eye images respectively in the first display area of the first image display 101 and the second display area of the second image display 102, and the three-dimensional image is generated based on the principle of parallax.

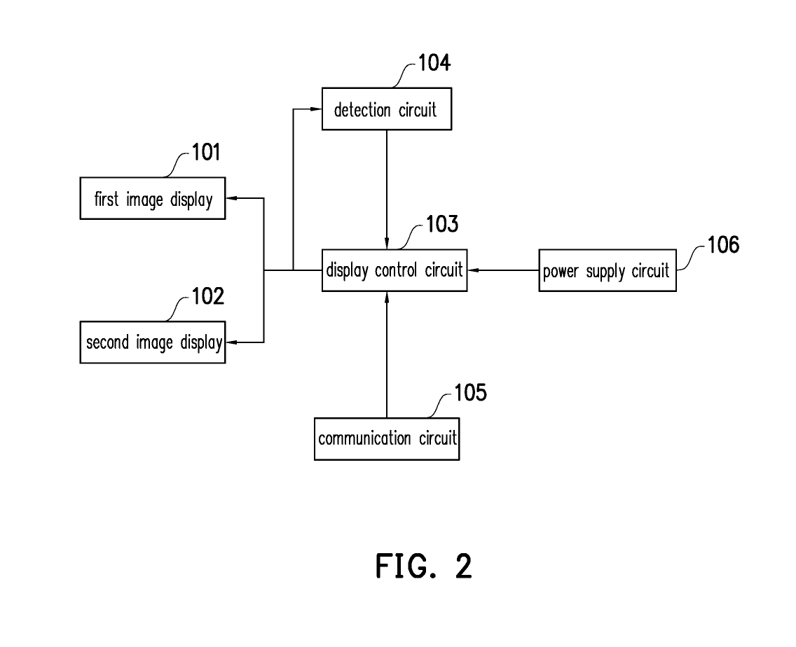

FIG. 2 is a schematic block diagram illustrating a display device according to an exemplary embodiment.

Referring to FIG. 2, the display device 100 includes the first image display 101, the second image display 102, a display control circuit 103, a detection circuit 104, a communication circuit 105, and a power supply circuit 106.

As mentioned above, the first image display 101 and the second image display 102 are configured to display an image. For example, the first image display 101 and the second image display 102 may include liquid crystal displays (LCD), light-emitting diode (LED) displays, field emission displays (FED), or displays of another type.

The display control circuit 103 is coupled to the first image display 101 and the second image display 102 and configured to control the first image display 101 and the second image display 102 to display an image. For example, the display control circuit 103 controls the first display area of the first image display 101 and the second display area of the second image display 102 to respectively display two different images that allow the user to view a three-dimensional image. For example, the display control circuit 103 may be a northbridge, a southbridge, a field programmable array (FPGA), a programmable logic device (PLD), an application specific integrated circuit (ASIC), another similar device, or a combination of the devices above. The display control circuit 103 may also be a central processing unit (CPU), a programmable microprocessor for general or specific purposes, a digital signal processor (DSP), a graphics processing unit (GPU), another similar device, or a combination of the devices above.

The detection circuit 104 is coupled to the display control circuit 103, the first image display 101, and the second image display 102 and is configured to detect positions of the first image display 101 and the second image display 102. Particularly, the detection circuit 104 calculates an included angle between a straight line connecting a visual center point of the first display area of the first image display 101 and a visual center point of the second display area of the second image display 102 and a horizontal line according to the detected positions of the first image display 101 and the second image display 102. In the present exemplary embodiment, the detection circuit 104 is provided with, for example, a leveler, a gyroscope, or any sensor capable of detecting linear motion, direction of linear motion, and rotational motion (e.g., an angular velocity of rotation and an angle of rotation) of the display device 100 to detect the positions of the first image display 101 and the second image display 102. However, it is understood that the disclosure is not limited hereto.

For example, in an exemplary embodiment, a plurality of transducers may be respectively disposed on the first image display 101 and the second image display 102 such that the detection circuit 104 independent of the display device 100 can detect the positions of the first image display 101 and the second image display 102 through the transducers on the first image display 101 and the second image display 102. Moreover, in another exemplary embodiment, other positioning sensors may also be used to track spatial positions of the first image display 101 and the second image display 102. For example, a plurality of light-sensitive transducers may be installed on the first image display 101 and the second image display 102. Based on a signal transmitted by an infrared laser transmitter disposed outside the display device 100, positions and motion trajectories of the first image display 101 and the second image display 102 are obtained to accurately track head motions of the user. Accordingly, the included angle between the straight line connecting the visual center point of the first display area of the first image display 101 and the visual center point of the second display area of the second image display 102 and the horizontal line is calculated according to the positions of the first image display 101 and the second image display 102.

The communication circuit 105 is coupled to the display control circuit 103 and is configured to receive an image signal via a wireless network. Specifically, after the communication circuit 105 receives a first image signal and a second image signal for presenting a three-dimensional image via the wireless network, the communication circuit 105 transmits the first image signal and the second image signal to the display control circuit 103, and the display control circuit 103 transmits the first image signal and the second image signal respectively to the first image display 101 and the second image display 102 to allow the user to view the three-dimensional image through the display device 100. For example, the communication circuit 105 is compatible with Bluetooth, Zigbee, WiFi, Global System for Mobile Communications (GSM), Wideband Code Division Multiple Access (WCDMA), Long Term Evolution (LTE), or another suitable standard. However, the disclosure is not limited hereto, and the communication circuit 105 may also receive an image signal via a wired network.

The power supply circuit 106 is coupled to the display control circuit 103 and is configured to supply power of the display device 100 through an internal power (e.g., a battery) or an external power.

In the present exemplary embodiment, the display control circuit 103 determines whether the included angle between the straight line connecting the visual center point of the first display area of the first image display 101 and the visual center point of the second display area of the second image display 102 and the horizontal line is not less than a predetermined angle according to a detection result of the detection circuit 104.

When it is determined that the included angle between the straight line connecting the visual center point of the first display area of the first image display 101 and the visual center point of the second display area of the second image display 102 and the horizontal line is less than the predetermined angle, the display control circuit 103 transmits the first image signal and the second image signal for presenting the three-dimensional image to the first image display 101 and the second image display 102 to generate a corresponding image. Accordingly, based on the principle of parallax, the user can see the three-dimensional image, and double images are not generated in the three-dimensional image.

When the included angle is not less than the predetermined angle, the display control circuit 103 switches the first image signal and the second image signal output to the first image display 101 and the second image display 102 to a third image signal. In other words, the first image display 101 and the second image display 102 simultaneously display the third image signal, namely, simultaneously displaying the same image signal. At this time, the left eye and the right eye of the user both see the same image, and the issue of double images does not occur. In the present exemplary embodiment, the third image signal is, for example, the first image signal or the second image signal.

In an exemplary embodiment, the predetermined angle is 0° plus or minus a tolerance angle. For example, the predetermined angle is 30°.

More specifically, an electronic device captures an image by using two camera lenses (not illustrated in the drawings) disposed in the electronic device. The two camera lenses capture images from a camera viewing angle at a horizontal angle. The camera viewing angle at the horizontal angle means that an included angle between a straight line connecting center points of the two camera lenses and the horizontal line is 0°. When the electronic device provides the image captured from the camera viewing angle at the horizontal angle to the display device 100, the electronic device provides the first image signal and the second image signal corresponding to the images captured by the two camera lenses from the camera viewing angle at the horizontal angle to the display device 100 to display the first image signal and the second image signal for presenting a three-dimensional image respectively on the first image display 101 and the second image display 102 of the display device 100.

When the user views the image captured by the electronic device at the horizontal angle with the head-mounted display, the user also views the image captured by the electronic device at the horizontal angle from a horizontal viewing angle. In other words, when the included angle between the straight line connecting the visual center point of the first display area of the first image display 101 disposed in the head-mounted display and the visual center point of the second display area of the second image display 102 disposed in the head-mounted display and the horizontal line is 0° plus or minus a tolerance angle, the first image signal and the second image signal for presenting the three-dimensional image are respectively transmitted to the first image display 101 and the second image display 102 to display the image. Due to the principle of parallax, the user sees a clear three-dimensional image, and double images are not generated.

When the detection circuit 104 detects tilt of the display device 100, namely, when the included angle between the straight line connecting the visual center point of the first display area of the first image display 101 and the visual center point of the second display area of the second image display 102 and the horizontal line is over 0° plus or minus a tolerance angle, double images may be generated. For example, when the included angle (0±tolerance angle) is not less than 30°, as the included angle increases, the double images that the user sees on the three-dimensional image become more significant.

When the display control circuit 103 determines that the included angle is not less than 30°, the display control circuit 103 switches the first image signal transmitted to the first image display 101 and the second image signal displayed on the second image display 102 simultaneously to the third image signal. At this time, the left eye and the right eye of the user both see the same image, and an image with double images is not generated.

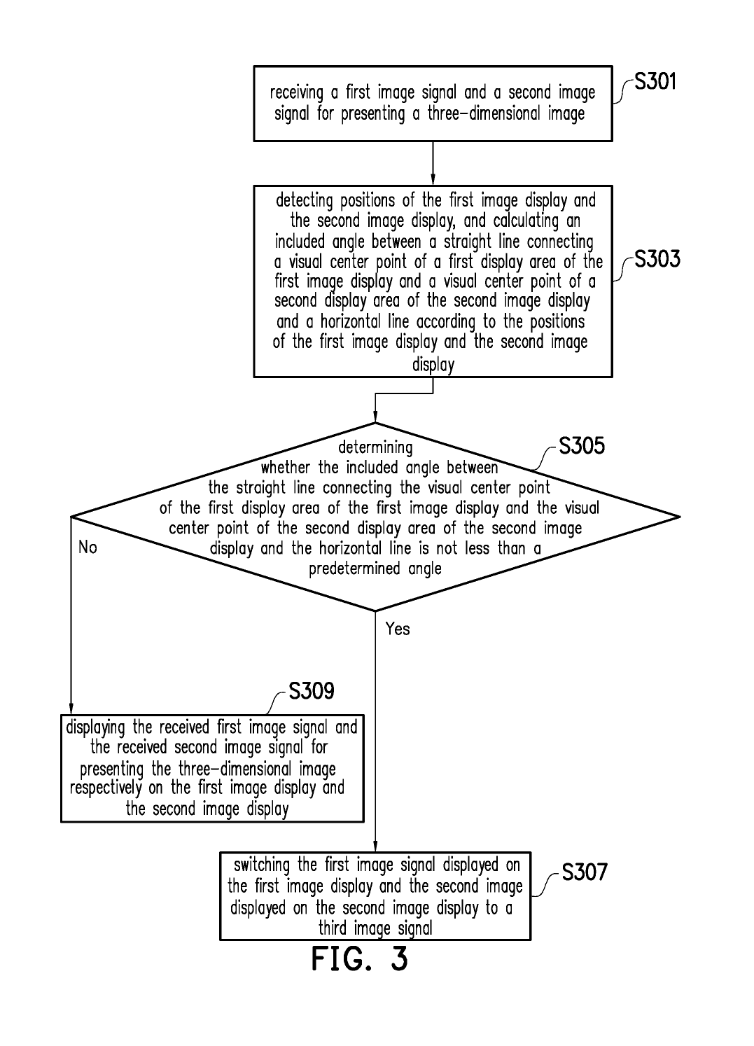

FIG. 3 is a flowchart illustrating a display method according to an exemplary embodiment.

Referring to FIG. 3, in step S301, the display control circuit 103 receives a first image signal and a second image signal for presenting a three-dimensional image.

In step S303, the detection circuit 104 detects positions of the first image display and the second image display, and calculates an included angle between a straight line connecting a visual center point of a first display area of the first image display and a visual center point of a second display area of the second image display and a horizontal line according to the positions of the first image display and the second image display.

In step S305, the display control circuit 103 determines whether the included angle between the straight line connecting the visual center point of the first display area of the first image display and the visual center point of the second display area of the second image display and the horizontal line is not less than a predetermined angle.

In step S307, when the included angle between the straight line connecting the visual center point of the first display area of the first image display and the visual center point of the second display area of the second image display and the horizontal line is not less than the predetermined angle, the display control circuit 103 switches the first image signal displayed on the first image display and the second image signal displayed on the second image display to a third image signal. In step S309, when the included angle between the straight line connecting the visual center point of the first display area of the first image display and the visual center point of the second display area of the second image display and the horizontal line is less than the predetermined angle, the received first image signal and the received second image signal for presenting the three-dimensional image are respectively displayed on the first image display and the second image display. Specifically, the predetermined angle is 30°.

In summary of the above, in the display device and the display method for the display device of the foregoing exemplary embodiments, when the user views the three-dimensional image with the head-mounted display and the user's head tilts by an angle over the predetermined angle, the first image signal transmitted to the first image display and the second image signal transmitted to the second image display are simultaneously switched to the same image signal, which thereby solves the issue of double images likely to be generated in the viewed three-dimensional image when the user's head tilts by an angle over the predetermined angle.

Although the disclosure is disclosed as the embodiments above, the embodiments are not meant to limit the disclosure. Any person skilled in the art may make slight modifications and variations without departing from the spirit and scope of the disclosure. Therefore, the protection scope of the disclosure shall be defined by the claims attached below.

What is claimed is:

1. A display device comprising:
an image display module; and
a display control circuit, coupled to the image display module, and configured to receive a first image signal and a second image signal for presenting a three-dimensional image,
wherein the display control circuit is further configured to determine whether an included angle between a straight line connecting a visual center point of a first display area in the image display module and a visual center point of a second display area in the image display module and a horizontal line is not less than a predetermined angle, and
wherein the display control circuit is further configured to switch the first image signal displayed on the first display area and the second image signal displayed on the second display area to a third image signal when the included angle between the straight line connecting the visual center point of the first display area in the image display module and the visual center point of the second display area in the image display module and the horizontal line is not less than the predetermined angle.

2. The display device according to claim 1, wherein
the image display module comprises a first image display and a second image display, wherein the first image display and the second image display are symmetrically disposed on two sides of a housing, and the first image display comprises the first display area and the second image display comprises the second display area.

3. The display device according to claim 1, wherein the display control circuit is further configured to display the received first image signal and the received second image signal for presenting the three-dimensional image respectively on the first display area and the second display area when the included angle between the straight line connecting the visual center point of the first display area in the image display module and the visual center point of the second display area in the image display module and the horizontal line is less than the predetermined angle.

4. The display device according to claim 1, wherein the predetermined angle is equal to 0°±X, and X is a tolerance angle.

5. The display device according to claim 1, wherein the third image signal is identical to the first image signal or is identical to the second image signal.

6. The display device according to claim 2, further comprising:
a detection circuit configured to detect positions of the first image display and the second image display, and calculate the included angle between the straight line connecting the visual center point of the first display area of the first image display and the visual center point of the second display area of the second image display and the horizontal line according to the positions of the first image display and the second image display.

7. The display device according to claim 6, wherein the detection circuit comprises a leveler or a gyroscope.

8. The display device according to claim 1, further comprising a communication circuit coupled to the display control circuit, wherein the communication circuit is configured to receive the first image signal and the second image signal via a wired network or a wireless network.

9. A display method for a display device, the display device comprising an image display module and a display control circuit coupled to the image display module, the image display module comprising a first display area and a second display area, the display method comprising:
receiving a first image signal and a second image signal for presenting a three-dimensional image;
determining whether an included angle between a straight line connecting a visual center point of the first display area in the image display module and a visual center point of the second display area in the image display module and a horizontal line is not less than a predetermined angle; and
switching the first image signal displayed on the first display area and the second image signal displayed on the second display area to a third image signal when the included angle between the straight line connecting the visual center point of the first display area in the image display module and the visual center point of the second display area in the image display module and the horizontal line is not less than the predetermined angle.

10. The display method according to claim 9, wherein the image display module comprises a first image display and a second image display symmetrically disposed on two sides of a housing.

11. The display method according to claim 9, wherein the received first image signal and the received second image signal for presenting the three-dimensional image are displayed respectively on the first display area and the second display area when the included angle between the straight line connecting the visual center point of the first display area in the image display module and the visual center point of the second display area in the image display module and the horizontal line is less than the predetermined angle.

12. The display method according to claim 9, wherein the predetermined angle is equal to 0°±X, and X is a tolerance angle.

13. The display method according to claim 9, wherein the third image signal is identical to the first image signal or is identical to the second image signal.

14. The display method according to claim 10, further comprising:
detecting positions of the first image display and the second image display, and calculating the included angle between the straight line connecting the visual center point of the first display area of the first image display and the visual center point of the second display area of the second image display and the horizontal line according to the positions of the first image display and the second image display.

15. The display method according to claim 9, further comprising:
receiving the first image signal and the second image signal via a wired network or a wireless network.
